(19) United States
(12) Patent Application Publication
(10) Pub. No.: US 2014/0033514 A1
(43) Pub. Date: Feb. 6, 2014

(54) ELECTRIC MACHINE WITH SINGLE OR DUAL-SHAPE WINDING CONFIGURATION AND METHOD

(71) Applicants: Bradley D. Chamberlin, Pendleton, IN (US); Steve Burton, Anderson, IN (US)

(72) Inventors: Bradley D. Chamberlin, Pendleton, IN (US); Steve Burton, Anderson, IN (US)

(73) Assignee: REMY TECHNOLOGIES, LLC, Pendleton, IN (US)

(21) Appl. No.: 13/567,372

(22) Filed: Aug. 6, 2012

(51) Int. Cl. H02K 15/085; H02K 15/00

(52) U.S. Cl. CPC H02K 15/085; H02K 15/0006
USPC 29/596

(57) ABSTRACT

A method of making a first stator winding and a second stator winding comprises forming an open winding arrangement on a first stator core, the open winding arrangement including conductor segments positioned in stator slots with at least four layers of conductor segments in each slot, the open winding arrangement further comprising a plurality of leads to a plurality of the conductor segments. The method further comprises forming the open winding arrangement on a second stator core. In addition, the method comprises closing the open winding arrangement on the first stator core by connecting the plurality of leads with first additional conductors to form a three phase winding in a single-shape configuration. Furthermore, the method comprises closing the open winding arrangement on the second stator core by connecting the plurality of leads with second additional conductors to form a three phase winding in a multi-shape configuration.

### FIELD

This application relates to the field of electric machines, and more particular to winding arrangements for electric machines.

### BACKGROUND

Multi-set segmented windings are commonly used in modern electrical machine applications, such as in hybrid-electric vehicles. These windings typically comprise a plurality of conductor segments which include two legs and a central U-turn portion between the legs. The U-shaped conductors are often formed with a rectangular cross-section. The U-shaped conductors are positioned in the slots of a core portion of the electric machine, such as the stator slots, to form windings for the machine. The term “U-shaped conductor segment” as used herein refers to a conductor segment that changes axial direction by more than 90°, such as by about 180°, but is not limited to conductor segments that forms a perfect “U” shape. Furthermore, the terms “conductor segment” and “segmented conductor” are used interchangeably herein and refer to a conductor having two ends, whether or not a U-shaped portion is included between the two ends, and such terms are not limited to U-shaped conductor segments.

Stator windings comprised of U-shaped conductor segments are formed by inserting the legs of the conductor segments into the slots of the stator core from one end of the stator core. Upon insertion of the legs into the slots, the U-turn portions are positioned on one side of the stator (the “insertion side”) and the leg ends extend from the other side of the stator (the “connection side” or “weld side”). The legs ends are then bent to appropriate positions, with a first leg of the U-shaped conductor segment typically bent in one direction and the second leg bent in the opposite direction. After the leg ends are bent, the entire segmented conductor extends a given slot span (e.g., 12 slots). Next, each leg end is connected to another leg end on the connection side of the stator to complete the windings. These connections include adjacent leg ends that are aligned directly and welded together, non-adjacent leg ends that are connected through jumper wires, and terminal connections that lead to the winding phases. Together, the connected conductors form the complete stator winding arrangement.

The proper placement of segmented conductors in particular slots is determined by engineers in advance of winding assembly. These winding arrangements are designed for a single winding configuration on a particular stator core. When a different winding configuration is desired, the engineers carefully plan a new arrangement for the conductor segments in the slots. However, it would be desirable to provide an electric machine winding arrangement that could be easily configured in one of two or more different winding configurations for use with different electric machine applications. In particular, it would be advantageous if a single winding arrangement could be provided on a stator core and selectively completed to produce one of multiple possible winding arrangements. It would also be advantageous if most of the connections on the winding arrangement could be made prior to selection of the desired winding arrangement. In addition, it would be advantageous if completion of the winding arrangement required relatively few connections between any remaining non-connected segmented conductors.

### SUMMARY

In accordance with one embodiment of the disclosure, there is provided a method of forming a winding for an electric machine. The method includes inserting a plurality of conductor segments into a plurality of slots in a core member having an insertion end and a connection end. Each of the conductor segments includes a slot portion extending through one of the plurality of slots and a leg end extending from the slot portion on the connection end of the core member. At least four conductor segments are inserted into each of the plurality of slots. Each of the at least four conductor segments defines a conductor layer such that at least four conductor layers are provided in the plurality of slots. The method further includes bending the leg ends of the conductor segments in a first conductor layer in a first direction and bending the leg ends of the conductor segments in a second layer in a second direction such that a first plurality of adjacent leg ends are formed between the conductor segments in the first conductor layer and the second conductor layer. In addition, the method includes bending the leg ends of the conductor segments in a third layer in the first direction and bending the leg ends of the conductor segments in the fourth layer in the second direction such that a second plurality of adjacent leg ends are formed between the conductor segments in the third layer and the fourth layer. Next, the method includes connecting the first plurality of adjacent leg ends and the second plurality of adjacent leg ends at the connection end of the core member. Furthermore, the method includes connecting a plurality of leg ends on the insertion end of the core member, wherein the connections between (i) the plurality of leg ends on the insertion end of the core member, (ii) the first plurality of adjacent leg ends, and (iii) the second plurality of adjacent leg ends form a partial winding with circuit openings. As a result, the circuit openings are configured for (a) selective closure to provide a complete winding with a single-shape winding arrangement and (b) selective closure to provide the complete winding a dual-shape winding arrangement. The method further includes selecting whether the circuit openings should be closed to provide the complete winding with the single-shape winding arrangement or the dual-shape winding arrangement. Finally, the method includes closing the circuit openings to provide the selected complete winding with the single-shape winding arrangement or the dual-shape winding arrangement.

Pursuant to another embodiment of the disclosure, there is provided a method of making a first stator winding and a second stator winding. The method comprises forming an open winding arrangement on a first stator core, the open winding arrangement including conductor segments positioned in stator slots with at least four layers of conductor segments in each slot, the open winding arrangement further comprising a plurality of leads to a plurality of the conductor segments. The method further comprises forming the open winding arrangement on a second stator core. In addition, the method comprises closing the open winding arrangement on the first stator core by connecting the plurality of leads with first additional conductors to form a three phase winding in a single-shape configuration. Furthermore, the method comprises closing the open winding arrangement on the second stator core by connecting the plurality of leads with second additional conductors to form a three phase winding in a multi-shape configuration.

In accordance with yet another embodiment of the disclosure, there is provided a method of converting a winding arrangement in a stator from a single-shape configuration to a dual-shape configuration. The stator includes a plurality of slots with at least four conductors in each slot. The method comprises removing a first electrical connection between a conductor in a first slot and a conductor in a second slot. In addition, the method comprises removing a second electrical connection between a conductor in a third slot and a conductor in a fourth slot. The method further comprises removing a third electrical connection between a conductor in a fifth slot and a conductor in a sixth slot. The method also comprises providing a first phase connection to the conductor in the first slot. Furthermore, the method comprises providing a second phase connection to the conductor in the third slot. In addition, the method comprises providing a third phase connection to the conductor in the fifth slot. The method also comprises providing a neutral connection to the conductors in the second, fourth and sixth slots.

The above described features and advantages, as well as others, will become more readily apparent to those of ordinary skill in the art by reference to the following detailed description and accompanying drawings. While it would be desirable to provide an electric machine winding arrangement and method that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a side view of a stator including a winding arrangement with segmented conductors;

FIG. 2 shows a top view of the stator core of FIG. 1 prior to insertion of the winding arrangement into the slots;

FIG. 3 shows a cross-section of a slot of the stator core showing the arrangement of conductors in the slot;

FIG. 4 shows a perspective view of a segmented conductor for the winding arrangement of the stator of FIG. 1;

FIGS. 5A-5C show a winding arrangement for the stator of FIG. 1 including a plurality of open connections;

FIG. 6A shows an embodiment of how the open connections of FIGS. 5A-5C may be completed to produce a single-Y winding arrangement;

FIG. 6B shows special connections on the insertion end of the stator for the single-Y winding arrangement of FIG. 6A;

FIG. 7A shows an embodiment of how the open connections of FIGS. 5A-5C may be completed to produce a dual-Y winding arrangement;

FIG. 7B shows special connections on the insertion end of the stator for the dual-Y winding arrangement of FIG. 7A;

FIG. 8 shows an exemplary method for making stators with the winding arrangement of FIGS. 5A-5C; and

FIG. 9 shows an alternative embodiment of a method for completing the open connections in the winding arrangement of FIGS. 5A-5C.

### DESCRIPTION

General Stator Configuration

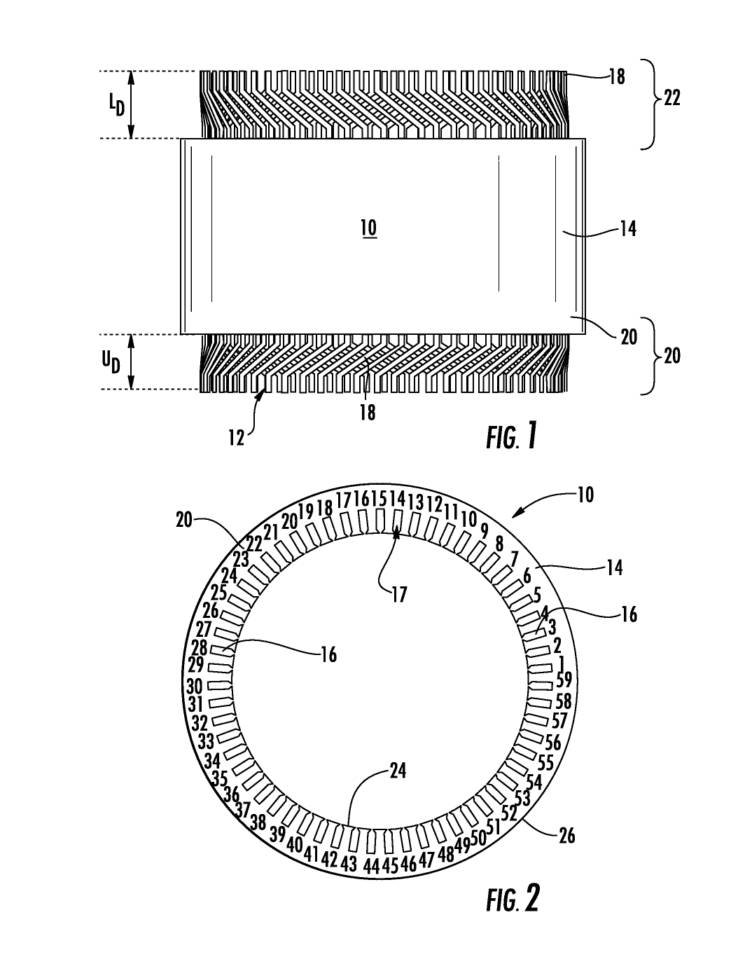

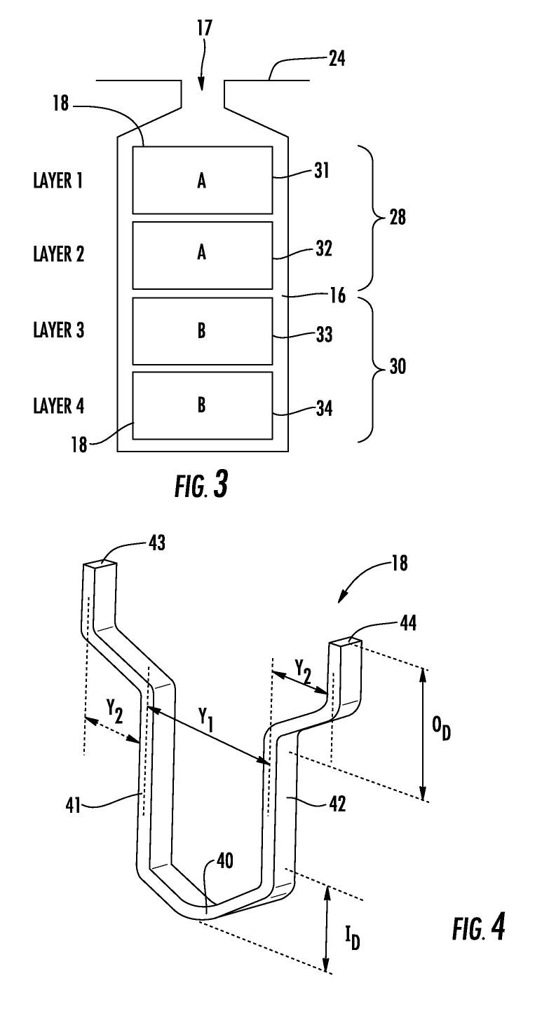

With reference to FIG. 1, a side view of an exemplary electric machine including a stator 10 is shown. The stator 10 includes a winding arrangement 12 positioned on a core member 12 of the electric machine (i.e., the stator core). The stator core 14 includes a main body portion with a plurality of slots 16 (see FIG. 2) formed therein. A plurality of segmented conductors 18 (which may also be referred to herein as “conductor segments”) are placed in slots of the stator 10 to form the armature winding arrangement 12. The segmented conductors 18 define an insertion side 20 of the stator 10 from which the segmented conductors are inserted into the slots. Opposite the insertion side 20 of the stator is a weld side 22 of the stator 10.

FIG. 2 shows a top view of the insertion side 20 of the exemplary stator core 14 of FIG. 1 without the segmented conductors 18 placed in the stator slots 16. As shown in FIG. 2, the stator core 14 is generally disc shaped with an inner circumferential perimeter 24 and an outer circumferential perimeter 26. The exemplary stator core 14 of FIG. 2 includes sixty slots 16. Openings 17 to the stator slots are provided through the inner perimeter 24 as well as the insertion side 20 and weld side 22 of the stator. The openings 17 are partially closed (or semi-closed), as illustrated by the reduced slot size at the opening 17.

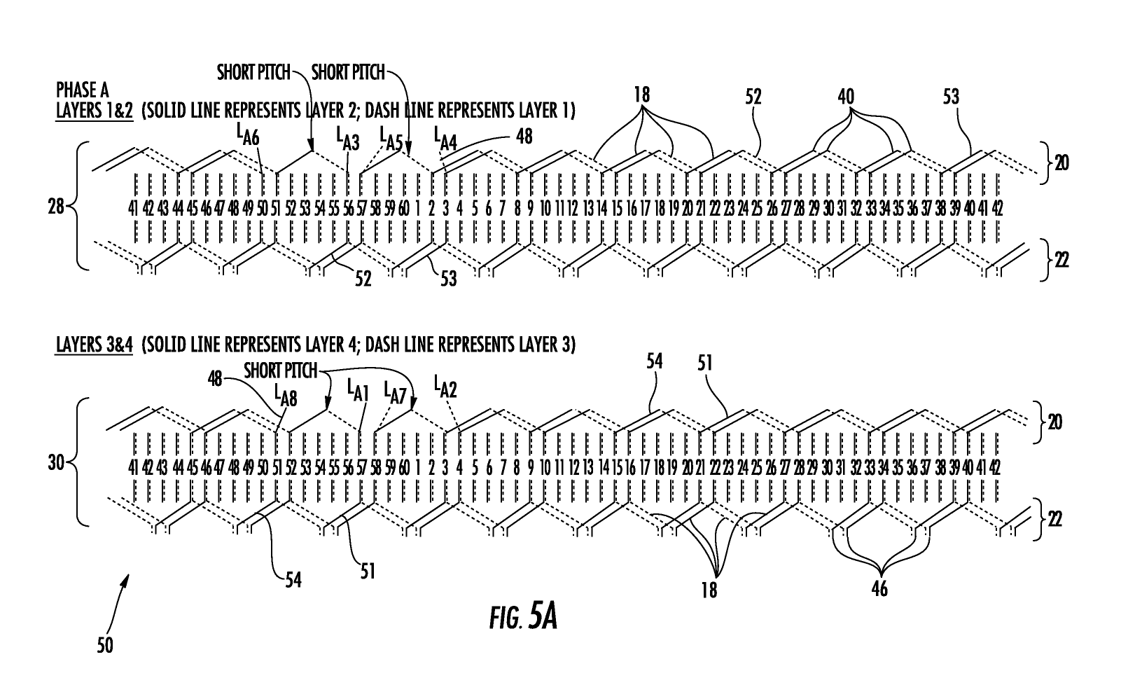

FIG. 3 shows an enlarged cross-sectional view of one of the slots 16 of the stator 10 with the segmented conductors 18 placed in the stator. As shown in FIG. 3, each slot 16 includes a total of four conductor segments 18, each conductor segment 18 having a generally rectangular cross-sectional shape. The rectangular conductor segments 18 are arranged in four layers in each slot 16. Layer one 31 is positioned closest to the inner perimeter 24 of the stator core 14. Layer one 31 is followed by layer two 32, layer three 33, and layer four 34 in each slot, with layer four 34 positioned closest to the outer perimeter 26 of the stator. Rectangular conductors 18 arranged in this manner in the slots 16 are useful in order to incorporate the advantages of semi-closed or fully-closed armature slots with a high slot fill ratio. Segmented conductors of this form are configured to further reduce AC resistance, as described in U.S. patent application Ser. No. 11/187,118, the contents of which are incorporated herein by reference in its entirety.

As explained in further detail below, the ends of the segmented conductors 18 are connected together to form two windings sets on the stator core 14. The conductors 18 from layer one 31 and layer two 32 form a first winding set 28, and the conductors 18 from layer three 33 and layer four 34 form the second winding set 30. As will be shown in further detail below, the conductor pair for each winding set in a given slot may carry current of the same phase or a different phase. For example, as shown in FIG. 3, the conductor pair for the first winding set 28 includes two conductors of phase A, and the conductor pair for the second winding set 30 includes two conductors of phase B. However, in other slots, the conductor pair for the first winding set 28 may be the same phase as the conductor pair for the second winding set 30. The exemplary winding arrangement 12 disclosed herein is a three phase winding arrangement, including phases A, B, and C. However, it will be recognized that principles disclosed herein may also be applied to other multi-phase arrangements.

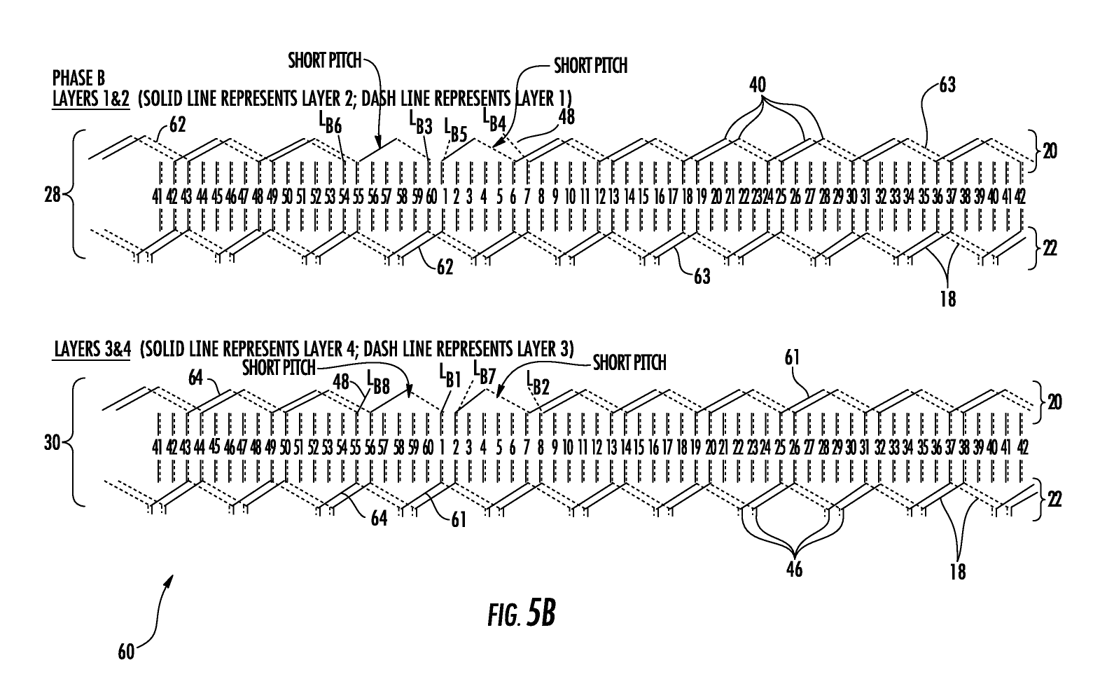

With reference now to FIG. 4, an exemplary segmented conductor 18 of rectangular cross-section is shown. The segmented conductor 18 includes two legs 41 and 42 separated by a U-shaped turn portion 40. Each leg 41, 42 includes an associated leg end 43, 44. The direction of the conductor 18 changes at the U-turn portion 40 such that the electrical path provided by the conductor makes a “U-turn” or a substantially 180° turn at the U-turn portion 40.

The segmented conductor 18 of FIG. 4 is formed from a straight conductor segment with a rectangular cross-section. However, before the straight conductor segment is inserted into the stator, a machine bends the conductor segment to create the U-turn portion 40 with two substantially straight legs 41, 42. After the U-turn portion 40 is created, the segmented conductor 18 is inserted into the stator core 14, legs first, from the insertion side 20 of the stator core 14. The two legs 41, 42 are inserted into different slots 16 of the stator core, with the two legs 41, 42 in different slot layers. The U-turn portion 40 of the conductor 18 spans a predetermined number of stator slots, as noted in FIG. 4 by the designation Y₁, showing that the distance between the legs is equal to a distance that traverses a given number of slots. The legs 41, 42 are made to pass through the respective stator slots 16 until they extend from the weld side 22 of the stator. After being inserted in the stator, the leg ends 43, 44 are bent by a machine in opposite directions by a predetermined distance, thus moving the leg ends 43, 44 of the conductor another predetermined number of slots. In FIG. 4 this distance is indicated as Y₂ slots.

After all the segmented conductors 18 are inserted into the slots 16 of the core 14, and the leg ends are bent, pairs of adjacent leg ends are provided on the connection side 22 of the stator core 14. Each pair of adjacent leg ends includes a first leg end is positioned in one slot and a second leg end positioned in a different slot. These adjacent leg ends are joined together on the connection end 22 of the stator to form a substantially completed stator winding arrangement. While most of the conductors segments 18 include U-turn portions 40 on the insertion side of the stator core 14, some conductor segments do not include U-turn portions, such that an unconnected leg end extends from the insertion side of the stator core. The remaining leg ends on the connection side 22 of the stator core 14 are then connected to jumpers, neutral connections, or phase terminals to complete the stator winding arrangement, as described in further detail below.

After all the conductor segments 18 are positioned on the stator core and connected together, the U-turn portion 40 of each segmented conductor 18 will extend a distance U_{D} (see FIG. 1) from the insertion side 20 of the stator 10. Similarly, the leg ends 43, 44 will extend a distance L_{D} (see FIG. 1) from the weld side 22 of the stator 10. In the embodiment disclosed herein, most of the conductors of the electric machine are of the same shape as that shown in FIG. 4. However, it will be recognized that conductors forming the first winding set 28 are slightly smaller in size than the conductors that form the second winding set 30, since the conductors in the second winding set must extend a slightly larger distance. Moreover, even though most of the conductors are the same general size and shape, it will be recognized that some of the conductors may have different shapes and sizes. For example, although most of the conductors in the embodiment disclosed herein are U-shaped conductors, it will be recognized that at least some of the conductors in the slots are not U-shaped conductors, and instead include opposing leg ends on different sides of the stator.

Partial Winding Arrangement

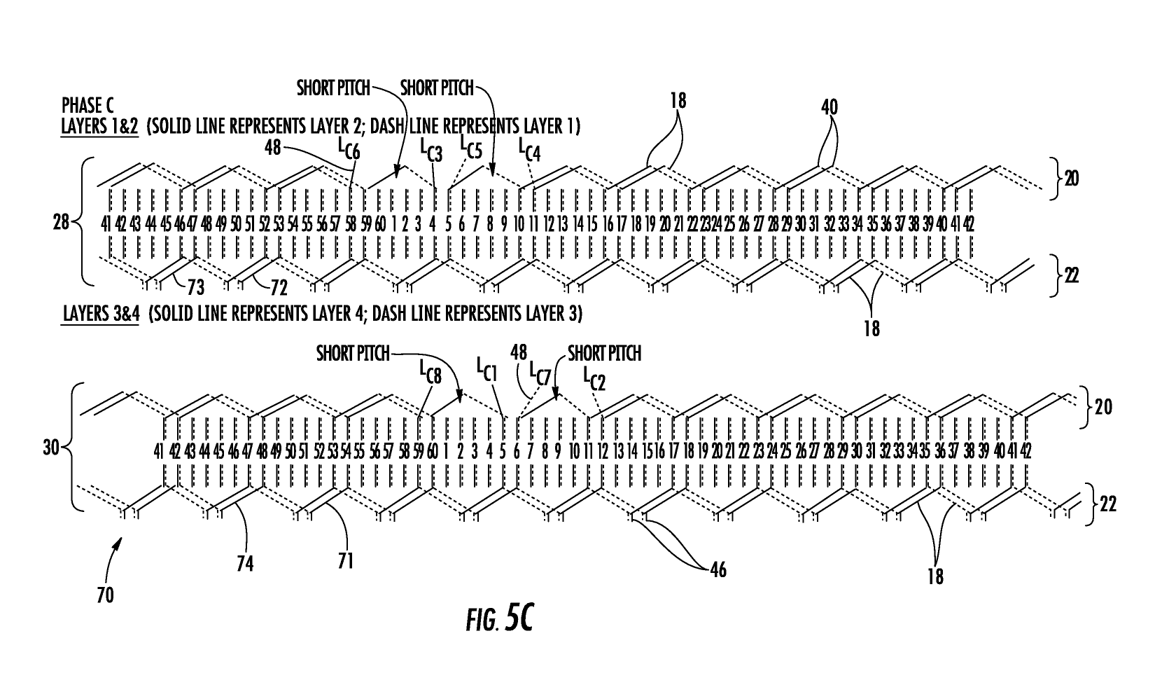

With reference now to FIGS. 5A-5C, a winding diagram is provided showing an exemplary winding arrangement 12 for a sixty slot stator. The winding arrangement 12 is a three phase winding arrangement. FIG. 5A shows the arrangement of the conductors 18 that make up the phase A winding 50, FIG. 5B shows the arrangement of the conductors 18 that make up the phase B winding 60, and FIG. 5C shows the arrangement of the conductors 18 that make up the phase C winding 70. Conductors positioned in layers one and two are shown in the top diagram, and conductors positioned in layers three and four are shown in the bottom diagram in each of FIGS. 5A-5C. Each phase winding 50, 60, 70, includes multiple winding sections. As used herein, the term “winding section” refers to a group of conductors 18 that complete a portion of a phase winding.

The phase windings 50, 60, 70 shown in FIGS. 5A-5C are comprised of wave windings retained within the stator slots 16 and circling around the stator core 14 numerous times. Each phase winding 50, 60, 70 shown in FIGS. 5A-5C includes four winding sections with each winding section substantially encircling the stator core two times. For example, as shown in FIG. 5A, two winding sections 52, 53 are positioned in layers one and two of the stator slots 16, and two winding sections 51, 54 are positioned in layers three and four of the stator slots 16. Similarly, as shown in FIG. 5B, two winding sections 62, 63 are positioned in layers one and two of the stator slots 16, and two winding sections 61, 64 are positioned in layers three and four of the stator slots 16. Also, as shown in FIG. 5C, two winding sections 72, 73 are positioned in layers one and two of the stator slots 16, and two winding sections 71, 74 are positioned in layers three and four of the stator slots 16. It will be recognized the term “winding section” as used herein refers to some portion of a phase winding. Accordingly, a “winding section” may include a portion of a phase winding that substantially completes multiple circles around the stator core, as shown in the embodiments of FIGS. 5A-5C, but may also include a portion of a phase winding that does not complete a circle around the stator core.

As can be seen from FIGS. 5A-5C, all connections between adjacent leg ends on the connection side 22 of the stator 10 are standard connections 46. These standard connections 46 may be made by any of various methods known in the art, including welding, heat staking, etc. All connections that are not standard connections between adjacent leg ends on the connection side of the stator may be referred to as “special connections”. In the embodiment disclosed herein, all special connections, including jumper, neutral, and terminal connections, are provided on the insertion side 20 of the stator 10. These special connections include the following: (i) the connections required to connect winding segments in a given phase in series or in parallel (i.e., connections between phase paths); (ii) the connections required to connect winding sets (i.e., the connection between conductors in layer two 32 and layer three 33); (iii) the neutral connections between different phase windings; and (iv) the terminal connections for each phase winding.

Each of FIGS. 5A-5C identifies a number of leads 48 where the special connections are made. The leads 48 are simply the ends of conductor segments 18 which are electrically connected using special connections to complete the winding arrangement 12. In FIG. 5A the special connections are made between leads L_{A1} to L_{A8}; in FIG. 5B the special connections are made between leads L_{B1} to L_{B8}; in FIG. 5C the special connections are made between leads L_{C1} to L_{C8}. As will be explained in further detail below, depending on how these leads 48 are connected together, the winding arrangement 12 may be configured as a single-shape winding arrangement (e.g., single-Y or single-Δ winding arrangement) or a dual-shape winding arrangement (e.g., dual-Y or dual-Δ winding arrangement).

Single-Y Winding Arrangement

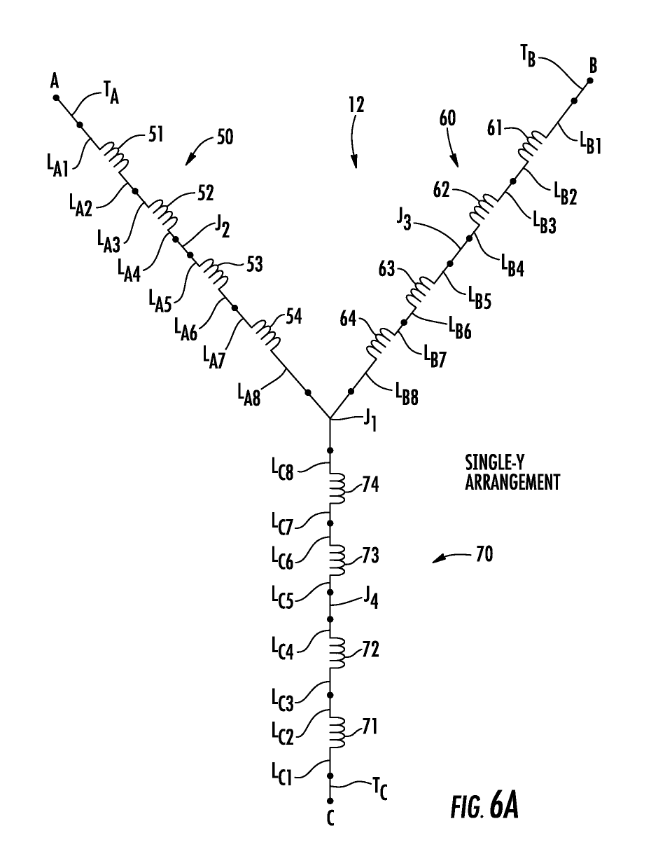

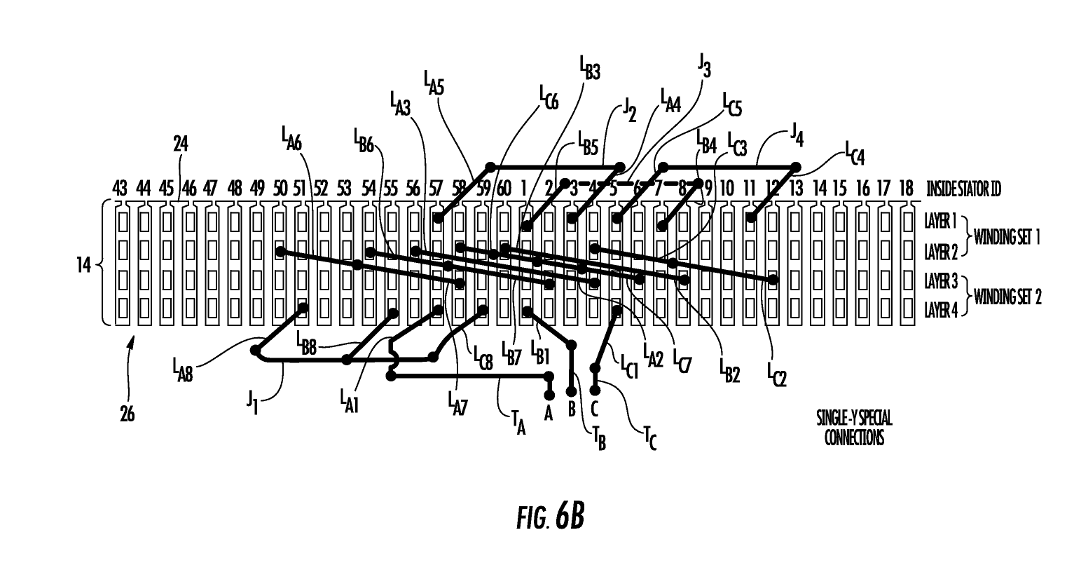

With reference now to FIG. 6A, in a first connection arrangement the leads 48 shown in FIGS. 5A-5C are connected together such that the winding sections 51-54, 61-64 and 71-74 complete the winding arrangement 12 in a single-shape winding arrangement (which may also be referred to herein as a “single-shape configuration”). In particular, in FIG. 6A the leads 48 are connected to form a single-Y configuration. In the phase A winding 50 lead L_{A1} is connected to the phase A terminal via terminal connection T_{A}. Lead L_{A2} is connected to L_{A3} in order to connect winding section 51 in series with winding section 52. Similarly, lead L_{A4} is connected to L_{A5} in order to connect winding section 52 in series with winding section 53. Also, lead L_{A6} is connected to L_{A7} in order to connect winding section 53 in series with winding section 54. Finally, lead L_{A8} is connected to jumper J1, which provides the neutral for the single-Y configuration of FIG. 6A.

With continued reference to FIG. 6A, in the phase B winding 60 lead L_{B1} is connected to the phase B terminal via terminal connection T_{B}. Lead L_{B2} is connected to L_{B3} in order to connect winding section 61 in series with winding section 62. Similarly, lead L_{B4} is connected to L_{B5} in order to connect winding section 62 in series with winding section 63. Also, lead L_{B6} is connected to L_{B7} in order to connect winding section 63 in series with winding section 64. Finally, lead L_{B8} is connected to neutral jumper J1.

In the phase C winding 70 lead L_{C1} is connected to the phase C terminal via terminal connection T_{C}. Lead L_{C2} is connected to L_{C3} in order to connect winding section 71 in series with winding section 72. Similarly, lead L_{C4} is connected to L_{C5} in order to connect winding section 72 in series with winding section 73. Also, lead L_{C6} is connected to L_{C7} in order to connect winding section 73 in series with winding section 74. Finally, lead L_{C8} is connected to neutral jumper J1.

With reference now to FIG. 6B, the positions of the special connections between the leads 48 are shown on the insertion side 20 of the stator 10 for the single-Y configuration of the winding arrangement 12 shown in FIG. 6A. As mentioned previously, the special connections include various jumpers, neutral connections, and terminal connections. The first set of special connections is provided between leads extending from the first layer of conductors in the stator slots 16, the first layer being nearest to the inner perimeter 24 of the stator core 14. This first set of special connections includes jumpers J₂, J₃, and J₄. Jumper J₂ connects lead L_{A5} and lead L_{A4}. Jumper J₃ connects lead L_{B5} and lead L_{B4}. Jumper J₄ connects lead L_{C5} and lead L_{C4}.

The second set of special connections is provided between leads extending from layer 2 and layer 3 at a central location between the inner perimeter 24 and the outer perimeter 26 of the stator core. The second set of special connections includes six jumpers or other connections joining leads extending from layer 2 to leads extending from layer 3. In particular, as illustrated in FIG. 6B, a first jumper connects L_{A6} extending from layer 2 to L_{A7} extending from layer 3. A second jumper connects L_{B6} extending from layer 2 to L_{B7} extending from layer 3. A third jumper connects L_{A3} extending from layer 2 to L_{A2} extending from layer 3. A fourth jumper connects L_{C6} extending from layer 2 to L_{C7} extending from layer 3. A fifth jumper connects L_{B3} extending from layer 2 to L_{B2} extending from layer 3. A sixth jumper connects L_{C3} extending from layer 2 to L_{C2} extending from layer 3.

With continued reference to FIG. 6B, the third set of special connections is provided between leads extending from the fourth layer of conductors 18 in the stator slots 16. The third set of special connections includes jumper J₁ and terminal connections T_{A}, T_{B}, and T_{C}. Jumper J₁ connects the three leads L_{A8}, L_{B8} and L_{C8}, providing the neutral connection of the Y winding arrangement shown in FIG. 6A. Terminal connection T_{A} is connected to L_{A1}, terminal connection T_{B} is connected to L_{B1}, and terminal connection T_{C} is connected to L_{C1}.

When all the leads of the open winding arrangement of FIGS. 5A-5C are completed as shown in FIG. 6B, it can be seen that the resulting single-Y winding arrangement includes winding sections that encircle the stator eight times per phase. For example, with respect to phase B shown in FIG. 5B, the following eight paths around the stator are shown:

Round #1
incoming phase lead starting in slot #1 via lead L_{B1}
winding starts in the counterclockwise direction (as viewed from insertion side)
conductors with a pitch of 6 are used to encircle the machine 1 time (1st leg in layer 3, 2nd leg in layer 4)
a conductor with a pitch of 5 is used to offset one slot (short pitch conductor)

Round #2
6 pitch conductors used to encircle the machine 1 time (1st leg in layer 3, 2nd leg in layer 4)
cross-over between layer 3 and layer 2 with an 8 pitch conductor (i.e., L_{B2} and L_{B3} may be provided by a single U-shaped conductor with the U-turn extending between layer 2 and layer 3)

Round #3
6 pitch conductors used to encircle the machine one time (1st leg in layer 1, 2nd leg in layer 2)
5 pitch conductor used to offset one slot (short pitch conductor)

Round #4
6 pitch conductors used to encircle the machine 1 time (1st leg in layer 1, 2nd leg in layer 2)
jumper within layer 1 by using a 6 pitch conductor to reverse winding direction (i.e., jumper J₃ connecting L_{B4} and L_{B5})

Round #5
winding starts in the clockwise direction.
6 pitch conductors used to encircle the machine one time (1st leg in layer 2, 2nd leg in layer 1)
5 pitch conductor used to offset one slot (short pitch conductor)

Round #6
6 pitch conductors used to encircle the machine 1 time (1st leg in layer 2, 2nd leg in layer 1)
cross-over between layer #2 & #3 with an 8 pitch conductor (i.e., L_{B6} and L_{B7} may be provided by a single U-shaped conductor with the U-turn extending between layer 2 and layer 3)

Round #7
6 pitch conductors used to encircle the machine 1 time (1st leg in layer 4, 2nd leg in layer 3)
5 pitch conductor used to offset one slot (short pitch conductor)

Round #8
6 pitch conductors used to encircle the machine 1 time (1st leg in layer 4, 2nd leg in layer 3)
End at neutral (i.e., J₁):

Dual-Y Winding Arrangement

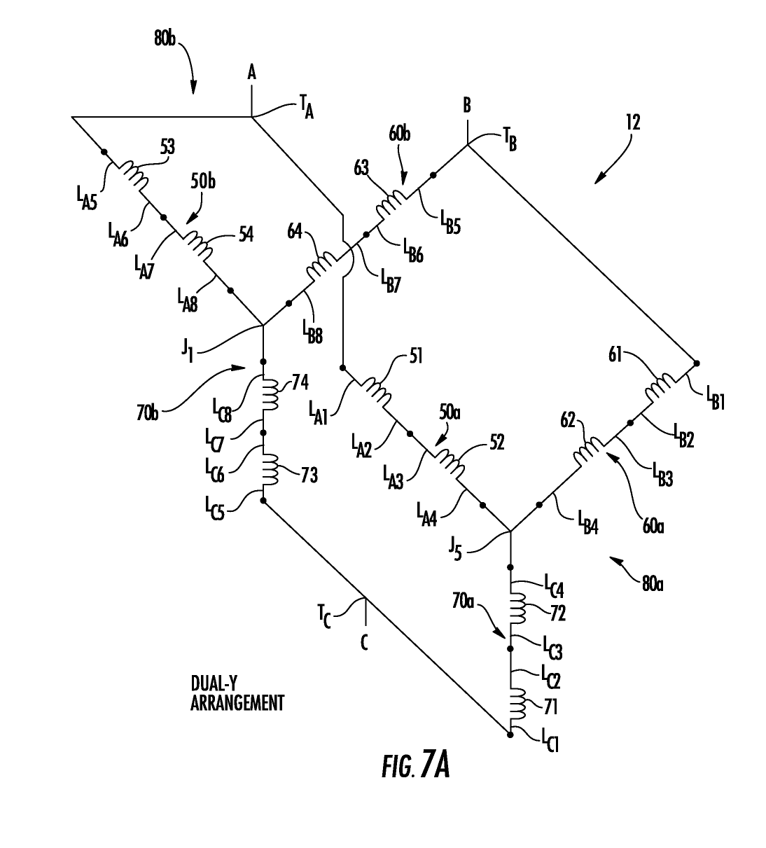

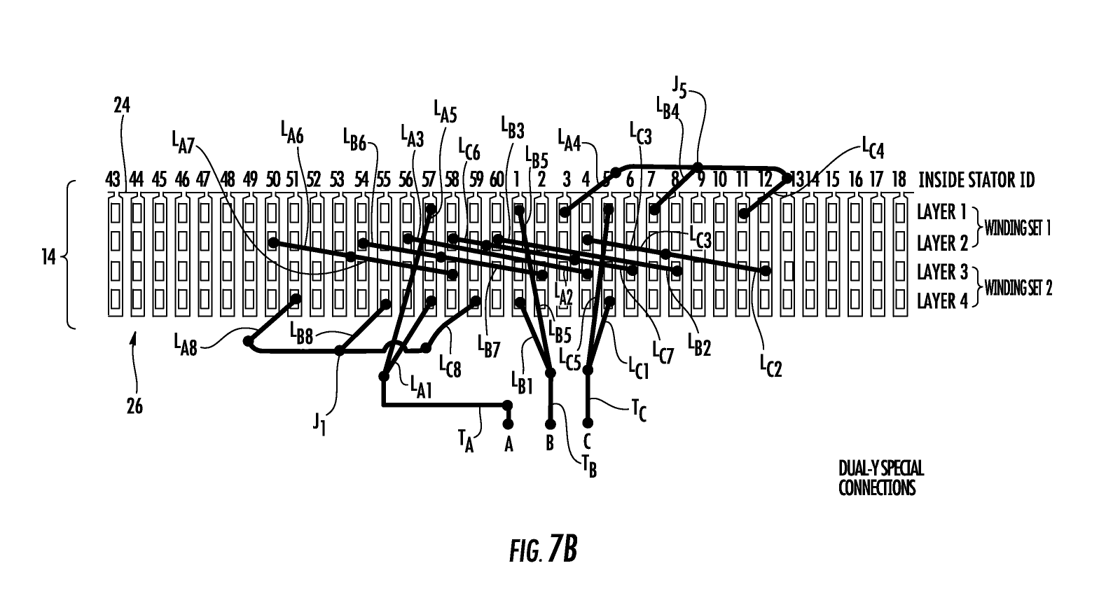

With reference now to FIG. 7A, a second possible connection arrangement for the winding arrangement of FIGS. 5A-5C is shown. In the second winding arrangement of FIG. 7A, the leads 48 are connected together such that the winding sections 51-54, 61-64 and 71-74 complete the winding arrangement 12 in a dual-shape winding arrangement (which may also be referred to herein as a “dual-shape configuration”). In particular, in FIG. 7A the leads 48 are connected to form a dual-Y configuration including a first Y section 80a and a second Y section 80b. The phase A winding includes branch 50a in the first Y section 80a and branch 50b in the second Y section 80b. Lead L_{A1} of branch 50a is connected to the phase A terminal via terminal connection T_{A}. Lead L_{A2} of branch 50a is connected to L_{A3} in order to connect winding section 51 in series with winding section 52. Lead L_{A4} is connected to jumper J5, which provides a neutral for the first Y section 80a. Lead L_{A5} of branch 50b is also connected to the phase A terminal via terminal connection T_{A}. Lead L_{A6} of branch 50b is connected to L_{A7} in order to connect winding section 53 in series with winding section 54. Lead L_{A8} is connected to jumper J1, which provides a neutral for the second Y section 80b. It will be appreciated that because jumpers J1 and J5 are unconnected, branches 50a and 50b of the phase A winding are not in parallel. However, it will also be appreciated that in other embodiments branches 50a and 50b may be connected in parallel by joining jumpers J1 and J5, resulting in a dual-shape winding arrangement that also includes parallel branches, such as branches 50a and 50b.

With continued reference to FIG. 7A, the phase B winding includes branch 60a in the first Y section 80a and branch 60b in the second Y section 80b. Lead L_{B1} of branch 60a is connected to the phase B terminal via terminal connection T_{B}. Lead L_{B2} of branch 60a is connected to L_{B3} in order to connect winding section 61 in series with winding section 62. Lead L_{B4} is connected to jumper J5, which provides the neutral for the first Y section 80a. Lead L_{B5} of branch 60b is also connected to the phase B terminal via terminal connection T_{B}. Lead L_{B6} of branch 60b is connected to L_{B7} in order to connect winding section 63 in series with winding section 64. Lead L_{B8} is connected to jumper J1, which provides the neutral for the second Y section 80b.

The phase C winding includes branch 70a in the first Y section 80a and branch 70b in the second Y section 80b. Lead L_{C1} of branch 70a is connected to the phase C terminal via terminal connection T_{C}. Lead L_{C2} of branch 70a is connected to L_{C3} in order to connect winding section 71 in series with winding section 72. Lead L_{C4} is connected to jumper J5, which provides the neutral for the first Y section 80a. Lead L_{C5} of branch 70b is also connected to the phase C terminal via terminal connection T_{C}. Lead L_{C6} of branch 70b is connected to L_{B7} in order to connect winding section 73 in series with winding section 74. Lead L_{C8} is connected to jumper J1, which provides the neutral for the second Y section 80b.

Again, it will be appreciated that because jumpers J1 and J5 are unconnected, the branches of the first Y section 80a are not in parallel with the branches of the second Y section 80b. However, it will also be appreciated that in other embodiments the branches may be connected in parallel by connecting jumpers J1 and J5, resulting in a dual-Y winding arrangement that also includes parallel branches, including parallel branches 50a and 50b, 60a and 60b, and 70a and 70b.

With reference now to FIG. 7B, the positions of the special connections between the leads 48 are shown on the insertion side 20 of the stator 10 for the dual-Y configuration of the winding arrangement 12 shown in FIG. 7A. Again, the special connections include various jumpers, neutral connections, and terminal connections. The first set of special connections is provided between leads extending from the first layer of conductors in the stator slots 16, the first layer being nearest to the inner perimeter 24 of the stator core 14. This first set of special connections includes jumper J₅ and terminal leads T_{A}, T_{B} and T_{C}. Jumper J₅ connects leads L_{A4}, L_{B4} and L_{C4}, and provides the neutral for the first Y section 80a of the dual-Y winding arrangement shown in FIG. 7A. Terminal lead T_{A} connects to lead L_{A5}, terminal lead T_{B} connects to lead L_{B5}, and terminal lead T_{C} connects to lead L_{C5}.

The second set of special connections is provided between leads extending from layer 2 and layer 3 at a central location between the inner perimeter 24 and the outer perimeter 26 of the stator core. The second set of special connections includes six jumpers or other connections joining leads extending from layer 2 to leads extending from layer 3. In particular, as illustrated in FIG. 7B, a first jumper connects L_{A6} extending from layer 2 to L_{A7} extending from layer 3. A second jumper connects L_{B6} extending from layer 2 to L_{B7} extending from layer 3. A third jumper connects L_{A3} extending from layer 2 to L_{A2} extending from layer 3. A fourth jumper connects L_{C6} extending from layer 2 to L_{C7} extending from layer 3. A fifth jumper connects L_{B3} extending from layer 2 to L_{B2} extending from layer 3. A sixth jumper connects L_{C3} extending from layer 2 to L_{C2} extending from layer 3.

With continued reference to FIG. 7B, the third set of special connections is provided between leads extending from the fourth layer of conductors 18 in the stator slots 16. The third set of special connections includes jumper J₁ and terminal connections T_{A}, T_{B}, and T_{C}. Jumper J₁ connects the three leads L_{A8}, L_{B8} and L_{C8}, providing the neutral connection of the second Y section 80b of the dual-Y winding arrangement shown in FIG. 7A. Terminal connection T_{A} is connected to L_{A1}, terminal connection T_{B} is connected to L_{B1}, and terminal connection T_{C} is connected to L_{C1}.

When all the leads of the open winding arrangement of FIGS. 5A-5C are completed as shown in FIG. 7B, it can be seen that the resulting dual-Y winding arrangement includes winding sections that encircle the stator eight times per phase. For example, with respect to phase B shown in FIG. 5B, the following eight paths around the stator are shown:

Round #1
incoming phase lead starting in slot #1 via lead L_{B1}
winding starts in the counterclockwise direction (as viewed from insertion side)
conductors with a 6 pitch are used to encircle the machine 1 time (1st leg in layer 3, 2nd leg in layer 4)
5 pitch conductor used to offset one slot (short pitch conductor)

Round #2
6 pitch conductors used to encircle the machine 1 time (1st leg in layer 3, 2nd leg in layer 4)
cross-over between layer #3 & #2 with an 8 pitch conductor (i.e., L_{B2} and L_{B3} may be provided by a single U-shaped conductor with the U-turn extending between layer 2 and layer 3)

Round #3
6 pitch conductors used to encircle the machine 1 time (1st leg in layer 1, 2nd leg in layer 2)
5 pitch conductor used to offset one slot (short pitch conductor)

Round #4
6 pitch conductors used to encircle the machine 1 time (1st leg in layer 1, 2nd leg in layer 2)
end at neutral (J₅)

Round #5
incoming phase lead starting in slot #1 via lead L_{B5}
winding starts in the clockwise direction (as viewed from insertion side)
6 pitch conductors used to encircle the machine 1 time (1st leg in layer 2, 2nd leg in layer 1)
5 pitch conductor used to offset one slot (short pitch conductor)

Round #6
6 pitch conductors used to encircle the machine 1 time (1st leg in layer 2, 2nd leg in layer 1)
cross-over between layer #2 & #3 with an 8 pitch conductor (i.e., L_{B6} and L_{B5} may be provided by a single U-shaped conductor with the U-turn extending between layer 2 and layer 3)

Round #7
6 pitch conductors used to encircle the machine 1 time (1st leg in layer 4, 2nd leg in layer 3)
5 pitch conductor used to offset one slot (short pitch conductor)

Round #8
6 pitch conductors used to encircle the machine 1 time (1st leg in layer 4, 2nd leg in layer 3)
end at neutral (J₁)

Conversion to Single-Y or Dual-Y Winding Arrangement

A comparison of FIGS. 6B and 7B reveals that the special connections are very similar for the single-Y arrangement of FIG. 6B and the dual-Y arrangement of FIG. 7B. In particular, the only difference between the special connections for the single-Y arrangement of FIG. 6B and the special connections for the dual-Y arrangement of FIG. 7B are the special connections in layer 1. Thus, in order to change the winding arrangement from a single-Y winding arrangement (as shown in FIG. 6A) to a dual-Y winding arrangement (as shown in FIG. 7A), the only changes that need to be made are changing the special connections for the innermost layer of conductors, which special connections are positioned on the insertion side 20 of the stator 10. Thus, in order to revise the single-shape winding arrangement of FIGS. 6A and 6B to the dual-shape winding arrangement of FIGS. 7A and 7B, the following steps are taken:

(i) remove the J₂ electrical connection between leads L_{A5} and L_{A4};

(ii) remove the J₃ electrical connection between leads L_{B5} and L_{B4};

(iii) remove the J₄ electrical connection between leads L_{C5} and L_{C4};

(iv) connect phase A terminal connection T_{A} to lead L_{A5};

(v) connect phase B terminal connection T_{B} to lead L_{B5};

(vi) connect phase C terminal connection T_{C} to lead L_{C5}; and

(vii) provide a neutral connection in the form of jumper J5 to leads L_{A4}, L_{B4} and L_{C4}.

Of course, the opposite procedures may be taken to revise the dual-shape winding arrangement of FIGS. 7A and 7B to the single-shape winding arrangement of FIGS. 6A and 6B.

As described above, the winding arrangement 12 is advantageously configured to be quickly and easily transformed between the single-Y arrangement of FIG. 6A and the dual-Y arrangement as shown in FIG. 7A, or vice-versa, by simply changing the connections to the leads stemming from the first layer of the stator slots. This provides manufacturers with the ability to easily convert existing inventory between different configurations. Furthermore, used stators in the field may be easily reconfigured to a different winding arrangement by simply switching the connections on the leads in the first layer of the stator slots.

Stator Manufacturing Method

In addition to the foregoing, the above-described stator arrangement allows for a flexible manufacturing line where stators may be substantially pre-assembled, and then quickly and easily configured at a later time in either a single-shape winding arrangement (e.g., a single-Y configuration) or a dual-shape winding arrangement (e.g., a dual-Y configuration). In particular, multiple stators may be substantially completed in advance with the special connections of layer 1 incomplete. Thereafter, each stator may be selectively completed with either a single-shape winding arrangement or a dual-shape winding arrangement by simply completing the special connections to the leads of layer 1 on the insertion side of the stator core.

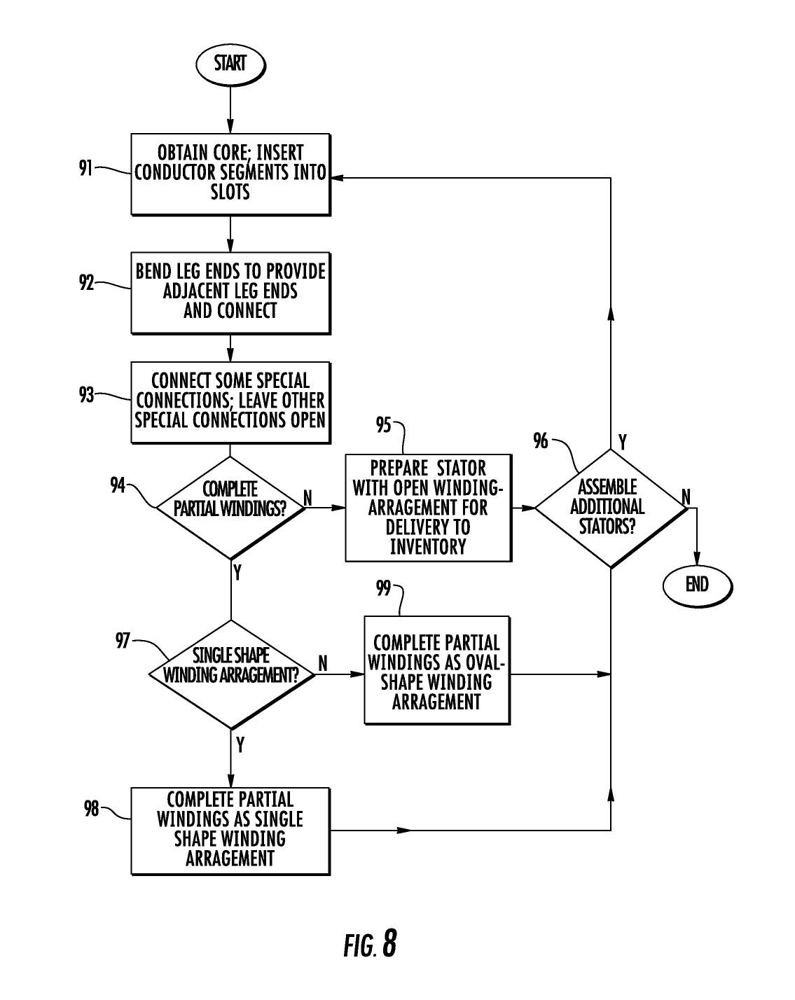

With reference to FIG. 8, a method of forming multiple stators for multiple electric machines is shown. The method begins with step 91, where a stator core is received and a plurality of conductor segments are inserted into the slots of the stator core. As described above, each of the conductor segments includes a slot portion extending through one of the plurality of slots and a leg end extending from the slot portion on the connection end of the stator core. At least four conductor segments are inserted into each of the plurality of slots of the stator core. Each of the at least four conductor segments defines a conductor layer such that at least four conductor layers are provided in the plurality of slots.

Next, in step 92, adjacent leg ends are formed and connected on the connection side 22 of the stator 10. To accomplish this, the leg ends of the conductor segments in the first conductor layer are bent in a first direction, and the leg ends of the conductor segments in the second layer are bent in a second direction such that a first plurality of adjacent leg ends are formed between the conductor segments in the first conductor layer and the second conductor layer. Simultaneously, the leg ends of the conductor segments in the third layer are also bent in the first direction and the leg ends of the conductor segments in the fourth layer are bent in the second direction such that a second plurality of adjacent leg ends are formed between the conductor segments in the third layer and the fourth layer.

After the leg ends are bent, the adjacent leg ends on the connection end of the stator are welded, soldered, heat-staked or otherwise connected together. In particular, the first plurality of adjacent leg ends are connected and the second plurality of adjacent leg ends are connected. This connection of adjacent leg ends forms a partial stator winding with circuit openings, such as that shown in the embodiment of FIGS. 5A-5C, wherein the leads 48 remain unconnected and resulting in the circuit openings. Such a winding with circuit openings may also be referred to herein as an “open winding arrangement”.

Next, in step 93, some of the special connections are made on the insertion side 20 of the stator 10. In particular, all leads extending from layers two, three and four are completed, as shown in FIGS. 6B and 7B. However, other leads including L_{A4}, L_{B4}, L_{C4}, L_{A5}, L_{B5} and L_{C5}, which all extend from conductors in layer one (i.e., the layer nearest the inside diameter of the stator core) are not connected and remain open. At this time, the stator has only a partial winding with the circuit openings on the stator winding (i.e., the unconnected leads extending from layer one) configured for (i) selective closure to provide a complete stator winding in the form of a single-shape winding arrangement, and (ii) selective closure to provide the complete stator winding arrangement in the form of a dual-shape winding arrangement.

In step 94, a determination is made whether the stator with an incomplete winding should be completed or moved to inventory. If the stator is to be moved to inventory, the stator is set aside for delivery to inventory, as noted in step 95. Then, in step 96, a decision is made whether additional stators with partial windings should be built. If the answer is yes, the method returns to step 91, and another stator is built with a partial winding. If the answer is no, the method ends.

If the determination from step 94 is that the stator with partial windings should be completed, the method moves to step 97. As noted above, the remaining circuit openings on the stator winding (i.e., the leads 48 extending from layer one) are configured for (i) selective closure to provide a complete stator winding in the form of a single-shape winding arrangement, and (ii) selective closure to provide the complete stator winding arrangement in the form of a dual-shape winding arrangement. Accordingly, a decision is made in step 97 whether the stator winding should be completed with a single-shape winding arrangement (e.g., a single-Y configuration) or a dual-shape winding arrangement (e.g., a dual-Y configuration).

Based on the decision in step 97, the method continues to one of steps 98 or 99. In step 98, the stator winding is completed with a single-shape winding arrangement such as that shown in FIG. 6A. To complete this winding, only those special connections from layer one need to be connected as shown in FIG. 6B in order to complete the single-Y winding (i.e., the special connections for leads L_{A4}, L_{B4}, L_{C4}, L_{A5}, L_{B5} and L_{C5} are completed as shown in FIG. 6B).

Alternatively, if the stator winding is to be completed with a dual-shape winding arrangement instead of a single-shape winding arrangement, the method moves to step 99. In this step, the stator winding is completed with a dual-shape winding arrangement such as the dual-Y winding shown in FIG. 7A. To complete this winding, only those special connections from layer one need to be connected as shown in FIG. 7B in order to complete the dual-Y configuration (i.e., the special connections for leads L_{A4}, L_{B4}, L_{C4}, L_{A5}, L_{B5} and L_{C5} are completed as shown in FIG. 7B).

In a related method to the one shown in FIG. 8, an existing inventory of stators with open winding arrangements exists. Accordingly, in this related method, a number of stators with open winding arrangements are selectively completed to have either single-shape or dual-shape winding arrangements. This method is similar to the method shown in FIG. 8, but steps 91-95 are removed since the stators are already completed with open winding arrangements. In this method, stators from inventory are completed according to steps 96-99, with a yes response from step 96 leading back to step 97.

The above-described arrangement provides for significant flexibility in the manufacturing line in which stator assemblies are produced. In particular, a single stator line may be used to pre-assemble stators that can later be easily configured with a single-shape winding arrangement or a dual-shape winding arrangement. Such a manufacturing arrangement may be particularly advantageous for high volume production where the stators may be differently configured in different products, such as production of the stators for use in electric machines that will serve as the power source for hybrid-electric vehicles.

Single or Dual shape Winding Arrangement Using Switching Members

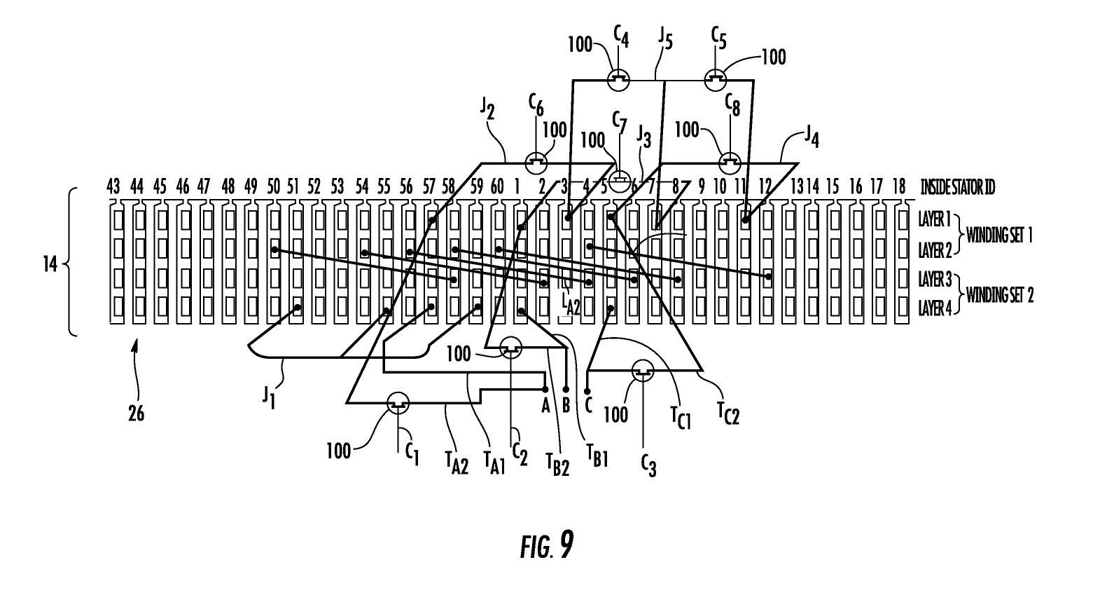

In at least one alternative embodiment, switches may be positioned between the leads 48, making it possible to perform switched stator winding operation. For example, as shown in FIG. 9, the special connections in layer 1 may be selectively changed between the arrangement of FIG. 6B and the arrangement of FIG. 7B by controlling the switching devices 100, which are provided as MOSFET devices in the embodiment of FIG. 9. Each switching device 100 is positioned in a jumper, or terminal connection such that control of the switching device will either enable or disable the jumper or terminal connection. In the embodiment of FIG. 9, a switching device is positioned in each of terminal connections T_{A2}, T_{B2}, and T_{C2}. In addition, switching devices 100 are positioned in jumpers J₂, J₃, J₄ and J₅. The switching devices 100 are controlled at leads C₁-C₈, which are all connected to a controller, such as a microprocessor or other logic device. The controller electronically controls the switching devices to provide a single-shape winding arrangement or a dual-shape winding arrangement. For example, if the winding arrangement is to be a single-shape winding arrangement such as that shown in FIG. 6A, the controller disables switching devices C₁-C₅, thus opening the connections for the associated terminal connections T_{A2}, T_{B2}, and T_{C2}, and jumper J₅, and enables switching devices C₆-C₈, thus closing the connections for jumpers J₂, J₃ and J₄. This results in a connection arrangement as shown in FIG. 6B. Alternatively, if the winding arrangement is to be a dual-shape winding arrangement such as that shown in FIG. 7A, the controller enables switching devices C1-C5, thus closing the connections for the associated terminal connections T_{A2}, T_{B2}, and T_{C2}, and jumper J₅, and disables switching devices C₆-C₈, thus opening the connections for jumpers J₂, J₃ and J₄. This results in a connection arrangement as shown in FIG. 7B.

The foregoing detailed description of one or more embodiments of the electric machine with single or dual-shape winding arrangement and method have been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A method of forming a winding for an electric machine, the method comprising:
inserting a plurality of conductor segments into a plurality of slots in a core member having an insertion end and a connection end, each of the conductor segments including a slot portion extending through one of the plurality of slots and a leg end extending from the slot portion on the connection end of the core member, wherein at least four conductor segments are inserted into each of the plurality of slots, each of the at least four conductor segments defining a conductor layer;
bending the leg ends of the conductor segments in a first conductor layer in a first direction and bending the leg ends of the conductor segments in a second layer in a second direction such that a first plurality of adjacent leg ends are formed between the conductor segments in the first conductor layer and the second conductor layer;
bending the leg ends of the conductor segments in a third layer in the first direction and bending the leg ends of the conductor segments in the fourth layer in the second direction such that a second plurality of adjacent leg ends are formed between the conductor segments in the third layer and the fourth layer;
connecting the first plurality of adjacent leg ends and the second plurality of adjacent leg ends at the connection end of the core member;
connecting a plurality of leg ends on the insertion end of the core member, wherein the connections between (i) the plurality of leg ends on the insertion end of the core member, (ii) the first plurality of adjacent leg ends, and (iii) the second plurality of adjacent leg ends form a partial winding with circuit openings, the circuit openings are configured for (a) selective closure to provide a complete winding with a single-shape winding arrangement and (b) selective closure to provide the complete winding a dual-shape winding arrangement;
selecting whether the circuit openings should be closed to provide the complete winding with the single-shape winding arrangement or the dual-shape winding arrangement; and
closing the circuit openings to provide the selected complete winding with the single-shape winding arrangement or the dual-shape winding arrangement.

2. The method of claim 1 wherein the single-shape winding arrangement is a single-Y winding arrangement, and wherein the dual-shape winding arrangement is a dual-Y winding arrangement.

3. The method of claim 1 wherein circuit openings are provided by at least six leads to six conductor segments that are not connected to other conductors, the six conductor segments including slot portions positioned in the same layer of the at least four conductor layers.

4. The method of claim 3 wherein the same layer is a radially inward-most layer of the at least four conductor layers.

5. The method of claim 4 wherein closing the circuit openings includes providing a first connection between a first pair of the conductor segments, providing a second connection between a second pair of the conductor segments, and providing a third connection between a third pair of the conductor segments to provide the complete winding with the single-shape winding arrangement.

6. The method of claim 5 wherein the first, second and third connections comprise first, second and third jumpers.

7. The method of claim 3 wherein closing the circuit openings includes providing a first phase terminal connection to a first of the conductor segments, providing a second phase terminal connection to a second of the conductor segments, providing a third phase terminal connection to a third of the conductor segments, and providing a neutral connection to a fourth, fifth and sixth of the conductor segments to provide the complete winding with the dual-shape winding arrangement.

8. The method of claim 1 wherein the circuit openings are formed by at least six leads extending from a single layer of the at least four conductor layers on the insertion end of the core member with no conductors coupled to one end of the at least six leads.

9. The method of claim 8 wherein closing the circuit openings includes providing a first jumper between a first pair of the at least six leads, providing a second jumper between a second pair of the at least six leads, and providing a third jumper between a third pair of the at least six leads to provide the complete winding with a single-shape winding arrangement.

10. The method of claim 1 wherein the complete winding is a three phase winding.

11. The method of claim 10 wherein the electric machine is a power source for a hybrid-electric vehicle.

12. The method of claim 1 wherein connecting the first plurality of adjacent leg ends and the second plurality of adjacent leg ends at the connection end of the core member is performed before selecting whether the circuit openings should be closed to provide the complete winding with the single-shape winding arrangement or the dual-shape winding arrangement.

13. The method of claim 1 wherein the circuit openings are provided at the insertion end of the core member.

14. The method of claim 1 wherein the circuit openings are all provided between conductor segments extending from the same conductor layer.

15. The method of claim 14 wherein the conductor layer is a conductor layer closest to an inner diameter of the core member.

16. The method of claim 1 wherein the plurality of conductor segments are U-shaped conductors having a substantially rectangular cross-section.

17. A method of making a first stator winding and a second stator winding, the method comprising:
forming an open winding arrangement on a first stator core, the open winding arrangement including conductor segments positioned in stator slots with at least four layers of conductor segments in each slot, the open winding arrangement further comprising a plurality of leads to a plurality of the conductor segments;
forming the open winding arrangement on a second stator core;
closing the open winding arrangement on the first stator core by connecting the plurality of leads with first additional conductors to form a three phase winding in a single-shape configuration; and
closing the open winding arrangement on the second stator core by connecting the plurality of leads with second additional conductors to form a three phase winding in a multi-shape configuration.

18. The method of claim 17 wherein the first additional conductors include jumpers extending between the plurality of leads, and wherein the second additional conductors include at least one jumper and at least three phase leads.

19. The method of claim 17,
wherein the open winding arrangement includes six leads;
wherein closing the open winding arrangement on the first stator core includes connecting the six leads to three jumpers such that each of the three jumpers connects a pair of the leads; and
wherein closing the open winding arrangement on the second stator core includes connecting the six leads to three phase leads and one jumper such that the one jumper connects three of the six leads and the three phase lead are each connected to one of the six leads.

20. A method of converting a winding arrangement in a stator from a single-shape configuration to a dual-shape configuration, the stator including a plurality of slots with at least four conductors in each slot, the method comprising:
removing a first electrical connection between a conductor in a first slot and a conductor in a second slot;
removing a second electrical connection between a conductor in a third slot and a conductor in a fourth slot;
removing a third electrical connection between a conductor in a fifth slot and a conductor in a sixth slot;
providing a first phase connection to the conductor in the first slot;
providing a second phase connection to the conductor in the third slot;
providing a third phase connection to the conductor in the fifth slot; and
providing a neutral connection to the conductors in the second, fourth and sixth slots.
